(19) United States
(12) Patent Application Publication
(10) Pub. No.: US 2026/0180230 A1
(43) Pub. Date: Jun. 25, 2026

(54) DC SOCKET

(71) Applicant: Schneider Electric Industries SAS, Rueil-Malmaison (FR)

(72) Inventors: Youliang Zhang, Shenzhen (CN); Dahai Zhang, Shenzhen (CN); Zhen Ma, Shenzhen (CN)

(73) Assignee: Schneider Electric Industries SAS, Rueil-Malmaison (FR)

(21) Appl. No.: 19/423,038

(22) Filed: Dec. 17, 2025

(30) Foreign Application Priority Data
Dec. 20, 2024 (CN) 202411896353.4

(51) Int. Cl. H01R 13/447; H01R 13/10; H01R 13/502; H01R 13/642; H01R 103/00

(52) U.S. Cl. CPC H01R 13/447; H01R 13/10; H01R 13/502; H01R 13/642; H01R 2103/00

(57) ABSTRACT

Embodiments of the disclosure provide a DC socket. The DC socket includes: a bracket including a pair of first through holes; a pair of socket contacts each disposed at the corresponding first through hole; a protective shutter slidable relative to the bracket between a first position and a second position along a first direction, where the protective shutter includes a pair of driving surfaces disposed at an angle to each other, one driving surface can be driven by the positive pin, and the other driving surface can be driven by the negative pin, where the first direction is arranged at an angle with respect to a width direction of the positive pin and a width direction of the negative pin, to enable the protective shutter to slide obliquely; and a covering member covering the protective shutter and the bracket and including a pair of second through holes.

### FIELD

Embodiments of the present disclosure generally relate to the technical field of electrical equipment, and more particularly, to a DC socket.

### BACKGROUND

A protective shutter is disposed in a socket and is located between insertion holes and socket contacts of the socket. The protective shutter is configured to prevent foreign objects from being accidentally inserted into the socket contacts through the insertion holes, thereby avoiding the occurrence of electric shock accidents.

Protective shutters in conventional sockets are usually driven by a single electrode pin to rotate. However, in a case where a positive pin and a negative pin for insertion into the socket are arranged perpendicular to each other, it is difficult to meet the requirements of a small-size design of the socket and the insertion of both the positive and negative pins. Thus, how to design a protective shutter that can be driven by both the positive and negative pins is an urgent technical problem to be solved currently.

### SUMMARY

It is an object of the present disclosure to provide a DC socket to at least partially solve the above problems.

In an aspect of the present disclosure, a DC socket is provided. The DC socket is adapted to mate with a positive pin and a negative pin of a plug that are perpendicular to each other. The DC socket includes: a bracket including a pair of first through holes; a pair of socket contacts each disposed at the corresponding first through hole; a protective shutter supported by the bracket and slidable relative to the bracket between a first position and a second position along a first direction, where the protective shutter includes a pair of driving surfaces disposed at an angle to each other, one driving surface of the pair of driving surfaces is located at an edge position of an end part of the protective shutter in a width direction of the negative pin and is adapted to be driven by the positive pin, and the other driving surface of the pair of driving surfaces is located at an edge position of a middle part of the protective shutter in a width direction of the positive pin and is adapted to be driven by the negative pin, where the first direction is arranged at an angle with respect to the width direction of the positive pin and the width direction of the negative pin, to enable the protective shutter to slide obliquely; and a covering member covering the protective shutter and the bracket and including a pair of second through holes each aligned with the corresponding first through hole. When the protective shutter is in the first position, the pair of driving surfaces are each aligned with the corresponding second through hole, and when the protective shutter is in the second position, the protective shutter is offset from the pair of second through holes.

Through the arrangement of the pair of driving surfaces according to embodiments of the present disclosure, during the process of inserting the plug into the DC socket, the positive pin and the negative pin can pass through the corresponding second through holes, drive the corresponding driving surfaces, and cause the protective shutter to slide along the first direction. Since the first direction is arranged at an angle with respect to the width direction of the positive pin and the width direction of the negative pin, the protective shutter can slide obliquely under the driving of the positive pin and the negative pin. With the above configuration, compared with the solution in which the protective shutter slides along the width direction of the positive pin or the width direction of the negative pin, the stroke of the protective shutter of the DC socket according to embodiments of the present disclosure in the DC socket is shortened, thereby meeting the requirements of a small-size design of the DC socket and smooth insertion of both the positive pin and negative pin.

In addition, since one driving surface of the pair of driving surfaces is located at the edge position of the end part of the protective shutter in the width direction of the negative pin, and the other driving surface of the pair of driving surfaces is located at the edge position of the middle part of the protective shutter in the width direction of the positive pin, the protective shutter according to embodiments of the present disclosure can achieve the purpose of its oblique sliding with a simple structure, with minor modifications required for the protective shutter. Thus, on one hand, it helps reduce costs; on the other hand, it helps ensure the stability of the sliding of the protective shutter, avoiding the problem of jamming caused by a complex driving mechanism during the process of driving the protective shutter to slide.

In some embodiments, the pair of driving surfaces are spaced apart from each other and are each arranged obliquely relative to an insertion direction of the corresponding pin of the positive pin and the negative pin, where one driving surface of the pair of driving surfaces extends along the width direction of the positive pin, and the other driving surface of the pair of driving surfaces extends along the width direction of the negative pin.

In some embodiments, the bracket further includes a first guide part extending along the first direction, the protective shutter further includes a second guide part, the first guide part is disposed between the pair of first through holes, the second guide part is disposed between the pair of driving surfaces, and the first guide part is configured to mate with the second guide part to enable the protective shutter to slide relative to the bracket.

In some embodiments, a gap is formed between the bracket and a side of the protective shutter adjacent to the pair of socket contacts, the second guide part includes a guide groove including a pair of side surfaces disposed obliquely, and a spacing between the pair of side surfaces gradually increases along a direction from the protective shutter to the pair of socket contacts to enable the protective shutter to be deflected relative to the bracket.

In some embodiments, the bracket further includes a first blocking part and a second blocking part, the first blocking part and the second blocking part are each adjacent to the corresponding first through hole and are located at two sides of the first guide part. In a case where one pin of the positive pin and the negative pin drives the corresponding driving surface, the protective shutter is adapted to be deflected relative to the bracket to a position where it is blocked by the first blocking part or the second blocking part.

In some embodiments, the covering member further includes a limiting part aligned with the first guide part, the protective shutter further includes a second top surface facing away from the pair of the socket contacts, the second top surface is connected to the pair of driving surfaces and includes a limiting surface, and the limiting part is in contact with the limiting surface.

In some embodiments, the second top surface further includes mating surfaces, the mating surfaces are separated by the limiting surface, and the mating surfaces and the covering member are spaced apart from each other to enable the protective shutter to be deflected relative to the bracket.

In some embodiments, the covering member further includes a third blocking part and a fourth blocking part that are each adjacent to the corresponding second through hole and are located at two sides of the limiting part. In a case where one pin of the positive pin and the negative pin drives the corresponding driving surface, the protective shutter is adapted to be deflected relative to the bracket to a position where it is blocked by the third blocking part or the fourth blocking part.

In some embodiments, the bracket further includes a mounting part and an elastic member that are arranged along the first direction, the protective shutter further includes a receiving groove adjacent to the pair of socket contacts, an end of the elastic member is connected to the mounting part, and the other end of the elastic member abuts against an inner surface of the receiving groove.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 shows a schematic diagram of the mating between a DC socket and a plug according to some embodiments of the present disclosure;

FIG. 2 shows a schematic structural diagram of a bracket, a protective shutter, base, and a mounting seat shown in FIG. 1;

FIG. 3 shows an exploded view of the bracket, a socket contact, the protective shutter, and the mounting seat shown in FIG. 1;

FIG. 4 shows an exploded view of a bracket and a protective shutter according to some embodiments of the present disclosure;

FIG. 5 shows a schematic structural diagram of a protective shutter and an elastic member according to some embodiments of the present disclosure; and

FIG. 6 shows a schematic structural diagram of a covering member according to some embodiments of the present disclosure.

Description of reference numerals:
100 DC socket, 200 plug, 201 positive pin, 202 negative pin;
1 bracket, 11 first through hole, 12 first guide part, 13 first blocking part, 14 second blocking part, 15 mounting part, 16 elastic member;
2 socket contact, 21 positive socket contact, 22 negative socket contact;
3 protective shutter, 31 driving surface, 32 second guide part, 321 first top surface, 322 side surface, 33 second top surface, 331 limiting surface, 332 mating surface, 34 receiving groove;
4 covering member, 41 second through hole, 42 limiting part, 43 third blocking part, 44 fourth blocking part;
5 cover plate, 51 third through hole; 6 base; 7 mounting seat;
X first direction; Y width direction of positive pin; Z width direction of negative pin.

### DETAILED DESCRIPTION

Embodiments of the present disclosure will be described in more detail below with reference to the accompanying drawings. While embodiments of the present disclosure are shown in the drawings, it should be understood that the present disclosure may be implemented in various forms and should not be limited by embodiments set forth herein. Rather, these embodiments are provided to make this disclosure more thorough and complete, and to fully convey the scope of the present disclosure to those skilled in the art.

As used herein, the term “including” and variations thereof represent openness, i.e., “including but not limited to”. Unless specifically stated, the term “or” means “and/or”. The term “based on” means “based at least in part on”. The terms “an example embodiment” and “an embodiment” mean “at least one example embodiment”. The term “another embodiment” means “at least one further embodiment”. The terms “first”, “second”, and the like may refer to different or identical objects.

As described above, protective shutters in conventional sockets are usually driven by a single electrode pin to rotate. However, in a case where a positive pin and a negative pin for insertion into the socket are arranged perpendicular to each other, a through hole corresponding to the positive pin and a through hole corresponding to the negative pin are perpendicular to each other. The inventor has noted that if it is desired to reduce the size of the socket, it is also necessary to shorten the stroke of the protective shutter. On this basis, if the protective shutter slides along an opening direction of any through hole, at least one of the through hole corresponding to the positive pin and the through hole corresponding to the negative pin may fail to be exposed, resulting in at least one of the positive pin and the negative pin failing to be inserted smoothly. Nevertheless, increasing the stroke of the protective shutter can resolve the problem of the pair of pins being unable to be inserted into, but this is not conducive to the small-size design of the socket.

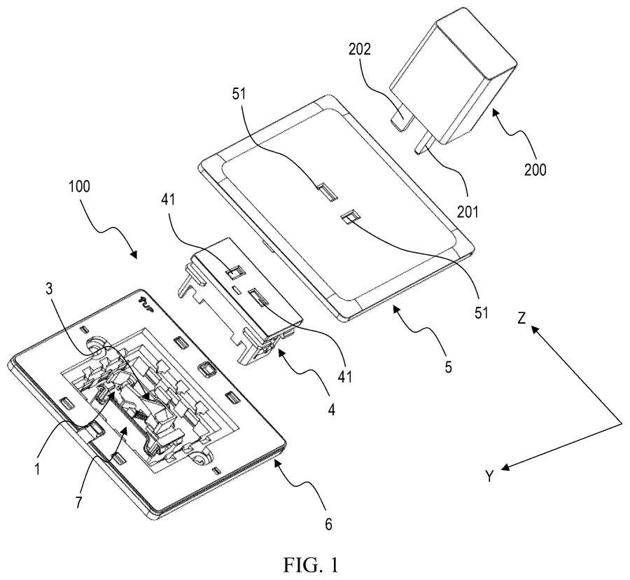

Based on this, embodiments of the present disclosure provide a DC socket 100 to at least partially solve the above problems. Hereinafter, the principles of the present disclosure will be described with reference to FIGS. 1 to 6.

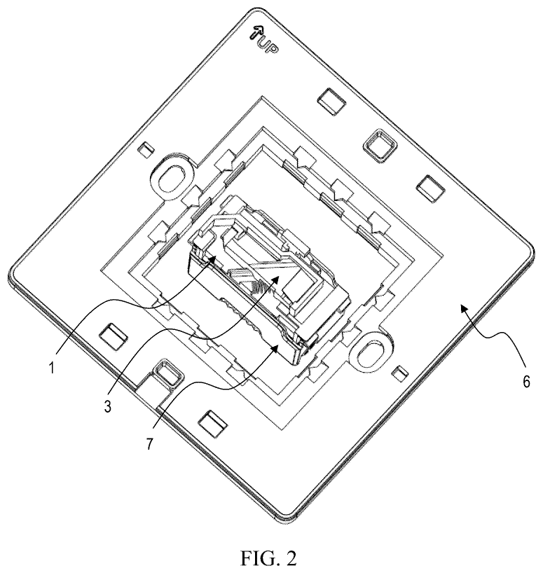

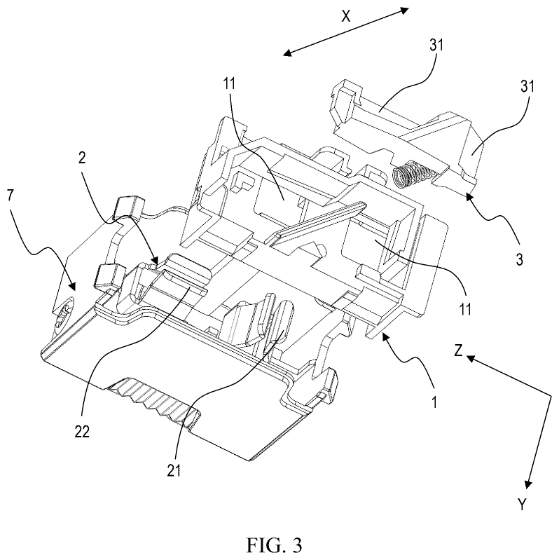

FIG. 1 shows a schematic diagram of the mating between a direct current, DC, socket 100 and a plug 200 according to some embodiments of the present disclosure. FIG. 2 shows a schematic structural diagram of a bracket 1, a protective shutter 3, a base 6, and a mounting seat 7 shown in FIG. 1. FIG. 3 shows an exploded view of the bracket 1, socket contacts 2, the protective shutter 3, and the mounting seat 7 shown in FIG. 1. As shown in FIGS. 1 to 3, the DC socket 100 described herein generally includes the bracket 1, the socket contacts 2, the protective shutter 3, a covering member 4, a cover plate 5, the base 6, and the mounting seat 7. The DC socket 100 may mate with a positive pin 201 and a negative pin 202 of a plug that are perpendicular to each other.

As shown in FIG. 1, in some embodiments, the cover plate 5 may cover the base 6 and be assembled to the base 6, and the cover plate 5 may further cover the bracket 1, a pair of socket contacts 2, the protective shutter 3, the covering member 4, and the mounting seat 7 to achieve a protective function. As shown in FIG. 3, the pair of socket contacts 2 may be located in the mounting seat 7 and can be limited in position by the bracket 1. With continued reference to FIGS. 1 and 2, the covering member 4 may cover the protective shutter 3 and the bracket 1, and the covering member 4 may be connected to the mounting seat 7 after being inserted into the base 6. In this way, the bracket 1, the socket contacts 2, the protective shutter 3, the covering member 4, the cover plate 5, the base 6, and the mounting seat 7 may be fixed as a whole.

With continued reference to FIG. 1, in some embodiments, the cover plate 5 may include a pair of third through holes 51, which can be used for the insertion of each corresponding pin of the positive pin 201 and the negative pin 202. The covering member 4 may include a pair of second through holes 41, which may also be used for the insertion of each corresponding pin of the positive pin 201 and the negative pin 202. The pair of second through holes 41 are each aligned with the corresponding third through hole 51, so that after being inserted into the corresponding third through holes 51, the positive pin 201 and the negative pin 202 can be further inserted into the corresponding second through holes 41, thereby enabling the positive pin 201 and the negative pin 202 to pass through the cover plate 5 and the covering member 4 in sequence.

With continued reference to FIGS. 1 and 3, in some embodiments, the bracket 1 may include a pair of first through holes 11. The pair of first through holes 11 are each aligned with the corresponding second through hole 41. The pair of socket contacts 2 are each disposed at the corresponding first through hole 11. For example, a portion of each of the pair of socket contacts 2 may pass through the corresponding first through hole 11. The protective shutter 3 is supported by the bracket 1, and the protective shutter 3 is slidable relative to the bracket 1 between a first position and a second position along a first direction X. The protective shutter 3 includes a pair of driving surfaces 31, the pair of driving surfaces 31 are each aligned with the corresponding second through hole 41. Therefore, the positive pin 201 and the negative pin 202 can drive the corresponding driving surfaces 31 after being inserted into the corresponding second through holes 41.

Further, with continued reference to FIG. 3, extending directions of the pair of driving surfaces 31 are arranged at an angle to each other. One driving surface 31 of the pair of driving surfaces 31 is located at an edge position of an end part of the protective shutter 3 in a width direction Z of the negative pin 202 and can be driven by the positive pin 201. The other driving surface 31 of the pair of driving surfaces 31 is located at an edge position of a middle part of the protective shutter 3 in a width direction Y of the positive pin 201 and can be driven by the negative pin 202. In addition, the first direction X is arranged at an angle with respect to the width direction Y of the positive pin 201 and the width direction Z of the negative pin 202. Thus, the protective shutter 3 can slide obliquely under the driving of the positive pin 201 and the negative pin 202.

When the protective shutter 3 is in the first position, the pair of driving surfaces 31 are each aligned with the corresponding second through hole 41. When the protective shutter 3 slides relative to the bracket 1 to the second position, since the protective shutter 3 is offset from the pair of second through holes 41, the positive pin 201 and the negative pin 202 can further be inserted into the corresponding first through holes 11 after passing through the corresponding second through holes 41 to draw power from the corresponding socket contacts 2.

Through the arrangement of the pair of driving surfaces 31 according to embodiments of the present disclosure, during the process of inserting the plug 200 into the DC socket 100, the positive pin 201 and the negative pin 202 can pass through the corresponding second through holes 41, drive the corresponding driving surfaces 31, and cause the protective shutter 3 to slide along the first direction X. Since the first direction X is arranged at an angle with respect to the width direction Y of the positive pin 201 and the width direction Z of the negative pin 202, the protective shutter 3 can slide obliquely under the driving of the positive pin 201 and the negative pin 202. With the above configuration, compared with the solution in which the protective shutter 3 slides along the width direction Y of the positive pin 201 or the width direction Z of the negative pin 202, the stroke of the protective shutter 3 of the DC socket 100 according to embodiments of the present disclosure in the DC socket 100 is shortened, thereby meeting the requirements of a small-size design of the DC socket 100 and smooth insertion of both the positive pin 201 and negative pin 202.

In addition, since one driving surface 31 of the pair of driving surfaces 31 is located at the edge position of the end part of the protective shutter 3 in the width direction Z of the negative pin 202, and the other driving surface 31 of the pair of driving surfaces 31 is located at the edge position of the middle part of the protective shutter 3 in the width direction of the positive pin 202, the pair of driving surfaces 31 according to embodiments of the present disclosure are both located at the edge of the protective shutter 3. Compared with the solution of arranging the driving surfaces 31 at the middle position or the depth position of the protective shutter 3, the protective shutter 3 according to embodiments of the present disclosure can achieve the purpose of its oblique sliding with a simple structure, with minor modifications required for the protective shutter 3. Thus, on one hand, it helps reduce costs; on the other hand, it helps ensure the stability of the sliding of the protective shutter 3, avoiding the problem of jamming caused by a complex driving mechanism during the process of driving the protective shutter 3 to slide.

Further, with continued reference to FIG. 3, the pair of socket contacts 2 may include a positive socket contact 21 and a negative socket contact 22. The positive pin 201 can be inserted into the corresponding first through hole 11 and be electrically connected to the positive socket contact 21. The negative pin 202 can be inserted into the corresponding first through hole 11 and be electrically connected to the negative socket contact 22.

With continued reference to FIG. 3, in some embodiments, the pair of driving surfaces 31 may be located at a side of the protective shutter 3 facing away from the pair of socket contacts 2, and the pair of driving surfaces 31 may be spaced apart from each other. The pair of drive surfaces 31 may be each arranged obliquely relative to an insertion direction of the corresponding pin of the positive pin 201 and the negative pin 202. Therefore, when the positive pin 201 and the negative pin 202 each press the corresponding driving surface 31, the protective shutter 3 can slide obliquely along the first direction X under the action of the component forces of the pressing forces exerted by the positive pin 201 and the negative pin 202 on the corresponding driving surfaces 31.

Further, one driving surface 31 of the pair of driving surfaces 31 may extend along the width direction Y of the positive pin 201, and the other driving surface 31 of the pair of driving surfaces 31 may extend along the width direction of the negative pin 202. Therefore, the protective shutter 3 can slide obliquely at 45° under the driving of the positive pin 201 and the negative pin 202, thereby minimizing the stroke of the protective shutter 3 and further facilitating the small-size design of the DC socket 100. In addition, it helps improve the stability of the sliding of the protective shutter 3, avoiding the problem of jamming caused by the complex driving mechanism during the process of driving the protective shutter 3 to slide. It should be understood that, in other embodiments, an extending direction of the driving surface 31 of the pair of driving surfaces 31 that is driven by the positive pin 201 may be arranged at an angle with respect to the width direction Y of the positive pin 201, and an extending direction of the driving surface 31 of the pair of driving surfaces 31 that is driven by the negative pin 202 may be arranged at an angle with respect to the width direction Z of the negative pin 202. For example, it may be deflected by 5-10 °, which is not limited herein.

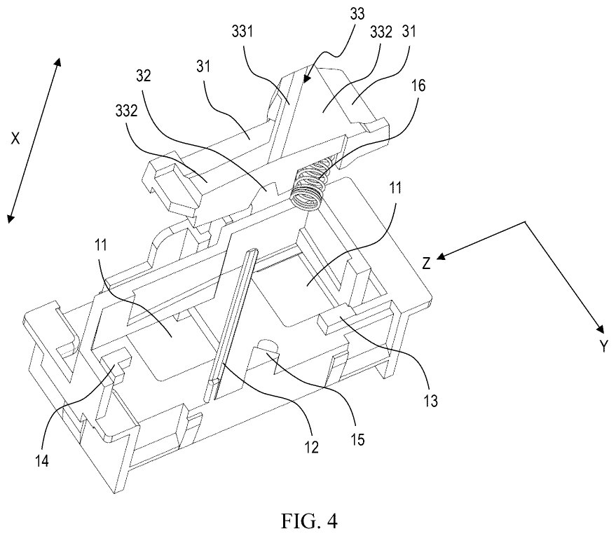

FIG. 4 shows an exploded view of the bracket 1 and the protective shutter 3 according to some embodiments of the present disclosure. As shown in FIGS. 2 to 4, in some embodiments, the bracket 1 may further include a first guide part 12 extending along the first direction X, and the first guide part 12 is configured to guide the protective shutter 3 so as to enable the protective shutter 3 to slide along the first direction X. Correspondingly, the protective shutter 3 may further include a second guide part 32 extending along the first direction X. The first guide part 12 may be disposed between the pair of first through holes 11, and the second guide part 32 may be disposed between the pair of driving surfaces 31. Therefore, when the pair of driving surfaces 31 are being driven, the protective shutter 3 can slide obliquely along the first direction X, and the stability of the sliding of the protective shutter 3 is improved, thereby effectively avoiding the problem of jamming caused by a complex driving mechanism during the process of driving the protective shutter 3 to slide. The first guide part 12 can mate with the second guide part 32, and thus, through the mating between the first guide part 12 and the second guide part 32, the protective shutter 3 can slide relative to the bracket 1.

Hereinafter, the principle of the present disclosure will be mainly illustratively described by taking the first guide part 12 including a guide protrusion and the second guide part 32 including a guide groove as an example. The case in which the first guide part 12 includes a guide groove and the second guide part 32 includes a guide protrusion is similar, and will not be repeated again herein.

It can be understood that, in a case where the first guide part 12 includes the guide protrusion, and the second guide part 32 includes the guide groove, at least a portion of the first guide part 12 is received in the second guide part 32, so that the protective shutter 3 can slide relative to the bracket 1.

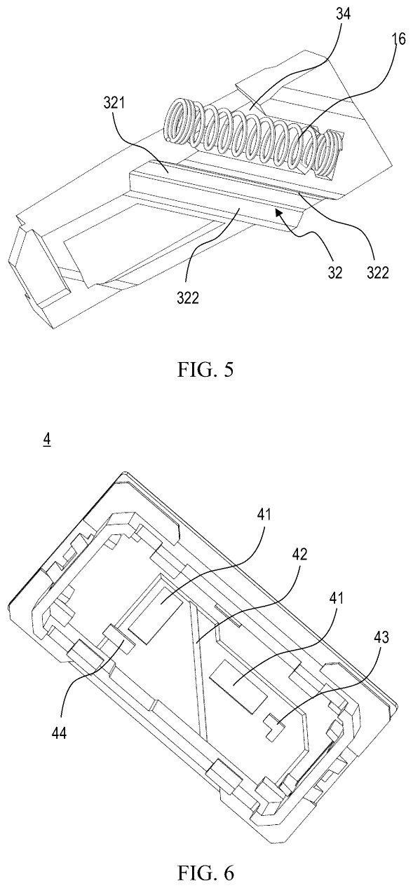

FIG. 5 shows a schematic structural diagram of a protective shutter 3 and an elastic member 16 according to some embodiments of the present disclosure. FIG. 6 shows a schematic structural diagram of a covering member 4 according to some embodiments of the present disclosure. As shown in FIGS. 4 to 5, in some embodiments, the second guide part 32 may include a first top surface 321, and the first guide part 12 may be in contact with the first top surface 321. Further, as shown in FIGS. 4 and 6, the covering member 4 may further include a limiting part 42 aligned with the first guide part 12, and the protective shutter 3 further includes a second top surface 33 facing away from the pair of socket contacts 2. The second top surface 33 may be connected to the pair of driving surfaces 31 and includes a limiting surface 331. The limiting surface 331 extends along the first direction X, and the limiting part 42 may be in contact with the limiting surface 331. Therefore, the upper end surface and the lower end surface of the protective shutter 3 are respectively in contact with the covering member 4 and the bracket 1, so as to improve the smoothness of the sliding of the protective shutter 3 relative to the bracket 1.

With continued reference to FIGS. 1 to 5, in some embodiments, in a case where one of the pair of third through holes 51 is inserted into, that is, when the DC socket 100 is inserted with a single pin, the protective shutter 3 can be deflected relative to the bracket 1. It can be understood that if the protective shutter 3 is deflected without sliding, the protective shutter 3 can prevent the pin from being further inserted, so as to realize an anti-single-pin insertion design, thereby improving the safety performance of the product.

Further, with reference to FIGS. 3 to 4, a gap may be formed between the bracket 1 and a side of the protective shutter 3 adjacent to the pair of socket contacts 2, and the gap can provide a space for the deflection of the protective shutter 3. Referring to FIGS. 3 to 5, the second guide part 32 may further include a pair of side surfaces 322 disposed obliquely. Since a spacing between the pair of side surfaces 322 gradually increases along a direction from the protective shutter 3 to the pair of socket contacts 2, the spacing between the pair of side surfaces 322 can further provide a space for the deflection of the protective shutter 3. With the above arrangement, when the DC socket 100 is inserted with a single pin, the protective shutter 3 can be deflected relative to the bracket 1 without sliding, so as to realize the anti-single-pin design, thereby improving the safety performance of the product.

Further, referring to FIGS. 3 to 4, the second top surface 33 may further include mating surfaces 332. The mating surfaces 332 may be separated by the limiting surface 331, and the mating surfaces 332 and the covering member 4 may be spaced apart from each other. This prevents the covering member 4 from interfering with the protective shutter 3, thereby enabling the protective shutter 3 to be deflected relative to the bracket 1.

With continued reference to FIG. 4, in some embodiments, the bracket 1 may further include a first blocking part 13 and a second blocking part 14. The first blocking part 13 and the second blocking part 14 may be each adjacent to the corresponding first through hole 11. The first blocking part 13 may be located at a side of the first guide part 12, and the second blocking part 14 may be located at an opposite side of the first guide part 12. Therefore, regardless of which one of the pair of driving surfaces 31 is driven, one of the first blocking part 13 and the second blocking part 14 can achieve a blocking effect, so as to avoid a problem that the protective shutter 3 can still slide along the first direction X after the protective shutter 3 is deflected.

With the above configuration, in a case where one of the positive pin 201 and the negative pin 202 drives the corresponding driving surface 31, the protective shutter 3 can be deflected relative to the bracket 1 to a position where it is blocked by the first blocking part 13 or the second blocking part 14, so that the protective shutter 3 cannot slide after being deflected, thereby achieving the anti-single-pin function.

Of course, since the covering member 4 covers the protective shutter 3, a feature for preventing the protective shutter 3 from sliding may also be provided on the covering member 4. For example, referring to FIG. 6, in some embodiments, the covering member 4 may further include a third blocking part 43 and a fourth blocking part 44. The third blocking part 43 and the fourth blocking part 44 may be each adjacent to the corresponding second through hole 41. The third blocking part 43 may be located at a side of the limiting part 42, and the fourth blocking part 44 may be located at an opposite side of the limiting part 42. Therefore, regardless of which one of the pair of driving surfaces 31 is driven, one of the third blocking part 43 and the fourth blocking part 44 can achieve a blocking effect, so as to avoid a problem that the protective shutter 3 can still slide along the first direction X after the protective shutter 3 is deflected.

With the above configuration, in the case where one of the positive pin 201 and the negative pin 202 drives the corresponding driving surface 31, the protective shutter 3 can be deflected relative to the bracket 1 to a position where it is blocked by the third blocking part 43 or the fourth blocking part 44, so that the protective shutter 3 cannot slide after being deflected, thereby achieving the anti-single-pin function.

It should be noted that, in some embodiments, the bracket 1 may include the first blocking part 13 and the second blocking part 14. In some other embodiments, the covering member 4 may include the third blocking part 43 and the fourth blocking part 44. In some other embodiments, when the bracket 1 includes the first blocking part 13 and the second blocking part 14, the covering member 4 may further include the third blocking part 43 and the fourth blocking part 44. Obviously, the anti-single-pin effect of the DC socket is improved through double-side blocking.

With continued reference to FIGS. 4 to 5, in some embodiments, the bracket 1 may further include a mounting part 15 and an elastic member 16. The elastic member 16 and the mounting part 15 may be arranged along the first direction X, and an end of the elastic member 16 may be connected to the mounting part 15, and the other end of the elastic member 16 may abut against the protective shutter 3. With the above configuration, during the process in which the protective shutter 3 is driven by the positive pin 201 and the negative pin 202 to slide along the first direction X, since the end of the elastic member 16 is blocked by the mounting part 15, the elastic member 16 can be compressed and store energy. When the positive pin 201 and the negative pin 202 are pulled out from the DC socket 100, the elastic member 16 can return the protective shutter 3 to the first position.

Further, with continued reference to FIGS. 4 to 5, the protective shutter 3 may further include a receiving groove 34 adjacent to the pair of socket contacts 2. the other end of the elastic member 16 facing away from the mounting part 15 abuts against an inner surface of the receiving groove 34. With the above configuration, during the process in which the protective shutter 3 is driven by the positive pin 201 and the negative pin 202 to slide along the first direction X, the elastic member 16 can be compressed and store energy.

In addition, the receiving groove 34 may extend along the first direction X, and a cross-sectional area of the mounting part 15 taken by a cross-section perpendicular to the first direction X may be smaller than a cross-sectional area of the receiving groove 34. Thus, when the sliding path of the protective shutter 3 is relatively long, the mounting part 15 will not interfere with the sliding of the protective shutter 3.

It should be noted that, in some other embodiments, as an alternative to the above solution, the mounting part 15 may be disposed on the covering member 4, and correspondingly, the receiving groove 34 may be located at the side of the protective shutter 3 facing away from the pair of socket contacts 2. An end of the elastic member 16 may be connected to the mounting part 15, and the other end of the elastic member 16 abuts against the inner surface of the receiving groove 34. With the above configuration, the elastic member 16 can also return the protective shutter 3 to the first position, which will not be repeated herein.

The elastic member 16 according to embodiments of the present disclosure may be various types of elastic members currently known or available in the future, which is not limited by embodiments of the present disclosure. For example, in some embodiments, the elastic member 16 may be a spring.

The design of the protective shutter 3 according to embodiments of the present disclosure may be applied to various DC socket 100 to at least partially solve the above problems. It should be understood that the design of the protective shutter 3 according to embodiments of the present disclosure may also be applied to other components, which is not limited by embodiments of the present disclosure.

Various embodiments of the present disclosure have been described above, which are illustrative, not exhaustive, and are not limited to embodiments disclosed. Many modifications and variations will be apparent to those of ordinary skill in the art without departing from the scope and spirit of the illustrated embodiments. The selection of the terms used herein is intended to explain the principles of embodiments, practical applications, or technical improvements in the marketplace, or to enable others of ordinary skill in the art to understand the embodiments disclosed herein.

1. A DC socket, wherein the DC socket is adapted to mate with a positive pin and a negative pin of a plug that are perpendicular to each other, and the DC socket comprises:
a bracket comprising a pair of first through holes;
a pair of socket contacts each disposed at the corresponding first through hole;
a protective shutter supported by the bracket and slidable relative to the bracket between a first position and a second position along a first direction, wherein the protective shutter comprises a pair of driving surfaces disposed at an angle to each other, one driving surface of the pair of driving surfaces is located at an edge position of an end part of the protective shutter in a width direction of the negative pin and is adapted to be driven by the positive pin, and the other driving surface of the pair of driving surfaces is located at an edge position of a middle part of the protective shutter in a width direction of the positive pin and is adapted to be driven by the negative pin, wherein the first direction is arranged at an angle with respect to the width direction of the positive pin and the width direction of the negative pin, to enable the protective shutter to slide obliquely; and
a covering member covering the protective shutter and the bracket and comprising a pair of second through holes each aligned with the corresponding first through hole, wherein when the protective shutter is in the first position, the pair of driving surfaces are each aligned with the corresponding second through hole, and when the protective shutter is in the second position, the protective shutter is offset from the pair of second through holes.

2. The DC socket of claim 1, wherein the pair of driving surfaces are spaced apart from each other and are each arranged obliquely relative to an insertion direction of the corresponding pin of the positive pin and the negative pin, wherein one driving surface of the pair of driving surfaces extends along the width direction of the positive pin, and the other driving surface of the pair of driving surfaces extends along the width direction of the negative pin.

3. The DC socket of claim 1, wherein the bracket further comprises a first guide part extending along the first direction, the protective shutter further comprises a second guide part, the first guide part is disposed between the pair of first through holes, the second guide part is disposed between the pair of driving surfaces, and the first guide part is configured to mate with the second guide part to enable the protective shutter to slide relative to the bracket.

4. The DC socket of claim 3, wherein a gap is formed between the bracket and a side of the protective shutter adjacent to the pair of socket contacts, the second guide part comprises a guide groove comprising a pair of side surfaces disposed obliquely, and a spacing between the pair of side surfaces gradually increases along a direction from the protective shutter to the pair of socket contacts to enable the protective shutter to be deflected relative to the bracket.

5. The DC socket of claim 4, wherein the bracket further comprises a first blocking part and a second blocking part, the first blocking part and the second blocking part are each adjacent to the corresponding first through hole and are located at two sides of the first guide part, and wherein in a case where one pin of the positive pin and the negative pin drives the corresponding driving surface, the protective shutter is adapted to be deflected relative to the bracket to a position where it is blocked by the first blocking part or the second blocking part.

6. The DC socket of claim 4, wherein the covering member further comprises a limiting part aligned with the first guide part, the protective shutter further comprises a second top surface facing away from the pair of the socket contacts, the second top surface is connected to the pair of driving surfaces and comprises a limiting surface, and the limiting part is in contact with the limiting surface.

7. The DC socket of claim 6, wherein the second top surface further comprises mating surfaces, the mating surfaces are separated by the limiting surface, and the mating surfaces and the covering member are spaced apart from each other to enable the protective shutter to be deflected relative to the bracket.

8. The DC socket of claim 6, wherein the covering member further comprises a third blocking part and a fourth blocking part that are each adjacent to the corresponding second through hole and are located at two sides of the limiting part, and wherein in a case where one pin of the positive pin and the negative pin drives the corresponding driving surface, the protective shutter is adapted to be deflected relative to the bracket to a position where it is blocked by the third blocking part or the fourth blocking part.

9. The DC socket of claim 1, wherein the bracket further comprises a mounting part and an elastic member that are arranged along the first direction, the protective shutter further comprises a receiving groove adjacent to the pair of socket contacts, an end of the elastic member is connected to the mounting part, and the other end of the elastic member abuts against an inner surface of the receiving groove.

10. The DC socket of claim 4, wherein the first guide part includes a guide protrusion, at least a portion of the first guide part is received in the second guide part.

11. The DC socket of claim 9, wherein the elastic member is a spring.
